(19) United States
(12) Patent Application Publication
(10) Pub. No.: US 2007/0271835 A1
(43) Pub. Date: Nov. 29, 2007

(54) Fish strike indicating apparatus

(76) Inventor: Joseph M. Wicinski, Staten Island, NY (US)

Correspondence Address: Joseph M. Wicinski, 275 Barnard Ave., Staten Island, NY, 10307, US

(21) Appl. No.: 11/438,837

(22) Filed: May 23, 2006

(51) Int. Cl. A01K 97/12

(52) U.S. Cl. 43/17

(57) ABSTRACT

A fish strike indicating apparatus is provided. The fish strike indicating apparatus includes a mounting unit for mounting to a rod holder, the mounting unit including a first portion and a second portion; an indicating unit for indicating movement of a fishing line, the indicating unit including a clip for connecting the indicating unit to a first end of the first portion of the mounting unit; and a detent unit for holding the indicating unit at a second end of the first portion of the mounting unit to a first end of the second portion of the mounting unit.

### BACKGROUND OF THE INVENTION

1. Technical Field

The present invention relates to fishing equipment, and more particularly, to a fish strike indicating apparatus.

2. Discussion of the Related Art

Over the years, a variety of audible and visual signaling devices have been provided to indicate whether a fish has struck or taken a baited line. The attraction of such devices is that they allow a fisherman to fish while using a line which may be largely unattended, to fish while using several lines or to fish at night. One of the oldest of these devices is a mechanical signaling apparatus such as a bell or rattle secured to the tip of a fishing rod which is activated by the jerking movement of the rod tip when a fish strikes. Other signaling devices of increasing complexity have been developed to serve this function.

Typically, these devices utilize batteries as a power source and may include an audible or visual alarm and a structure for closing a switch in a circuit to activate the alarm. The alarm may be activated, for example, when a fishing rod on which it is located deviates from a relatively static position, when tension is exerted on the fishing line or when the fishing line is moved in a linear manner such as that which occurs when a fish strikes or takes the bait. Generally, the more complex bite detector devices fall into one of two categories.

In one category are bite detectors that include some sort of level responsive switch. While in another category, are those devices that detect movement of the fishing line. For level detecting devices, a switch that is responsive to positional change is mounted to a fishing rod, and connected in series with a power source and an indicator such as a buzzer, light or both. For devices that detect movement of the fishing line, they tend to include a structure for closing a switch in a circuit to actuate an alarm when tension is exerted on the fishing line, or when the fishing line is moved when a fish strikes the hook or takes the bait.

In order for a fisherman to leave the fishing rod unattended while waiting for a fish to take the bait, the fisherman may place the handle of the rod into a rod holder. A rod holder can be a fixed device such as that found on a boat, vehicle or fishing pier railing or the holder could be an unfixed device such as a sand spike. A rod holder is generally shaped as a tube, the inside diameter thereof being large enough to accept the handle of a fishing rod. By placing the handle of the rod into the tube, the fishing rod can be supported in an upright position and the fisherman can be relieved from the obligation of manually holding the rod. For example, in surf fishing, a sand spike can be driven into the sand of a beach to hold a fishing rod. The use of several sand spikes allows a fisherman to operate several fishing rods, thereby enabling the fisherman to engage in other activities while awaiting a fish.

Although most conventional rod mounted fish strike indicators are useful for their intended purpose, they must generally be removed prior to casting and re-mounted afterwards so that they do not become dislodged from the rod or cause the fishing line to become tangled. Further, some conventional fish strike indicators can only be mounted on the handle of the rod, thereby precluding placement of the rod in a rod holder.

### SUMMARY OF THE INVENTION

The present invention provides a fish strike indicating apparatus that can be affixed to a fishing rod holder, such as a sand spike, the apparatus indicating whether a fish has struck or taken a baited line by illuminating a light emitting element for a predetermined amount of time.

In one embodiment of the present invention, a fish strike indicating apparatus includes a mounting unit for mounting to a rod holder, the mounting unit including a first portion and a second portion; an indicating unit for indicating movement of a fishing line, the indicating unit including a clip for connecting the indicating unit to a first end of the first portion of the mounting unit; and a detent unit for holding the indicating unit at a second end of the first portion of the mounting unit to a first end of the second portion of the mounting unit.

The fish strike indicating apparatus further comprises a fastener for fastening the mounting unit to the rod holder. The fastener is Velcro. The rod holder is a sand spike.

The detent is a ball detent. The ball detent comprises: a ball bearing for holding the indicating unit in a temporarily fixed position; a washer for securing the ball bearing in the ball detent; and a hollow bolt including, a spring for pushing the ball bearing against the indicating unit; and a nut for adjusting tension between the spring and the ball bearing.

The mounting unit further comprises a first opening and a second opening in the first portion of the mounting unit. The clip further comprises a first protruding connector and a second protruding connector for inserting into the first and second openings to connect the clip to the first portion of the mounting unit.

The mounting unit further comprises: a third opening and a fourth opening in the first portion of the mounting unit; and a line snag prevent having a first protruding connector and a second protruding connector for inserting into the third and fourth openings.

The indicating unit further comprises: a battery; a timer; a printed circuit; and a light emitting element. The light emitting element is an LED, OLED or a light bulb.

The indicating unit is encased in a housing, the housing comprising a first portion and a second portion, the first portion for storing the battery, timer, printed circuit, and light emitting element, the second portion for displaying light emitted by the light emitting element.

The first portion of the housing is coupled to the second portion of the housing via a coupling means.

In yet another embodiment of the present invention, a fish strike indicating apparatus, comprises: a mounting unit for mounting to a rod holder, the mounting unit including a pair of sloped sides and a hollow threaded insert; an indicating unit for indicating movement of a fishing line, the indicating unit including a connector for pivotally connecting to the mounting unit via the sloped sides, a concave portion and a light source for emitting light upon movement of the fishing line; and a detent unit coupled through the hollow threaded insert, the detent unit including a ball bearing for resting in the concave portion of the indicating unit and a threaded bolt for adjustably securing the indicating unit against the ball bearing.

The rod holder is a plastic sleeve. The mounting unit further comprises a snag prevent for prevent the fishing line from being snagged in between the indicating unit and the sloped sides upon movement of the fishing line.

Upon movement of the fishing line, the indicating unit is released from the detent unit and thrust in an outward direction while remaining pivotally connected to the sloped sides. The snag prevent is a wire or piece of metal.

The indicating unit comprises: a spring connected to a power source, the power source connected to the light source, the light source disposed on a printed circuit board; a metal strip connected at one end between the spring and the power source and connected at another end to the printed circuit board; a switch connected to the printed circuit board, the switch responsive to movement of the fishing line to energize the light source; and a timing circuit for controlling a rate at which the light bulb is energized, wherein the rate at which the light bulb is energized determines an amount of time the light source is illuminated.

The foregoing features are of representative embodiments and are presented to assist in understanding the invention. It should be understood that they are not intended to be considered limitations on the invention as defined by the claims, or limitations on equivalents to the claims. Therefore, this summary of features should not be considered dispositive in determining equivalents. Additional features of the invention will become apparent in the following description, from the drawings and from the claims.

### BRIEF DESCRIPTION OF THE DRAWINGS

FIG. 1 is a fish strike indicating apparatus according to an exemplary embodiment of the present invention;

FIG. 2 is an indicator/fishing rod holder mount as shown in FIG. 1;

FIG. 3 is a fish strike indicator as shown in FIG. 1;

FIG. 4 is an exploded view of the fish strike indicator of FIG. 3; and

FIG. 5 is the fish strike indicating apparatus of FIG. 1 mounted on a sand spike according to an exemplary embodiment of the present invention.

### DETAILED DESCRIPTION OF EXEMPLARY EMBODIMENTS

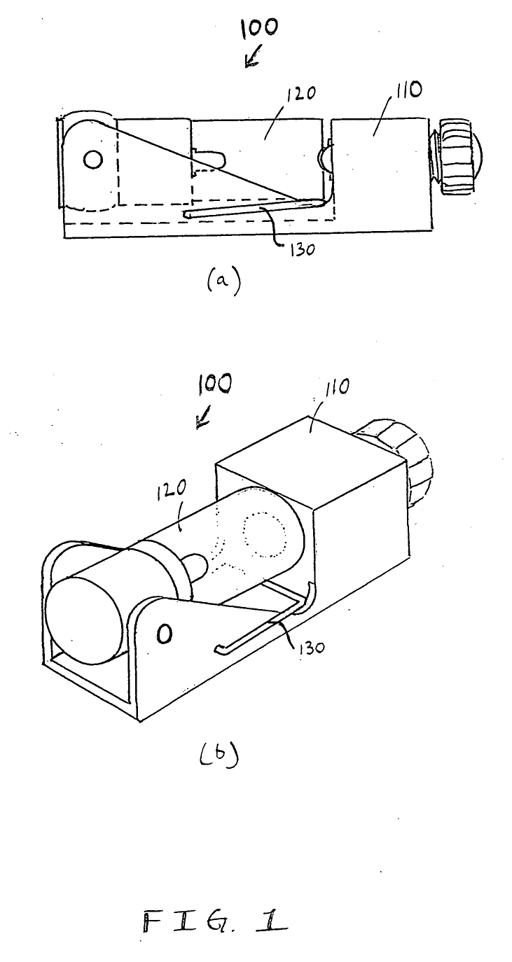

FIG. 1 illustrates a fish strike indicating apparatus 100 according to an embodiment of the present invention. As shown in images (a) and (b) of FIG. 1, the fish strike indicating apparatus 100 includes an indicator/fishing rod holder mount 110 and a fish strike indicator 120. The fish strike indicator 120 will hereinafter be referred to as the indicating unit and the indicator/fishing rod holder mount 110 will hereinafter be referred to as the mounting unit.

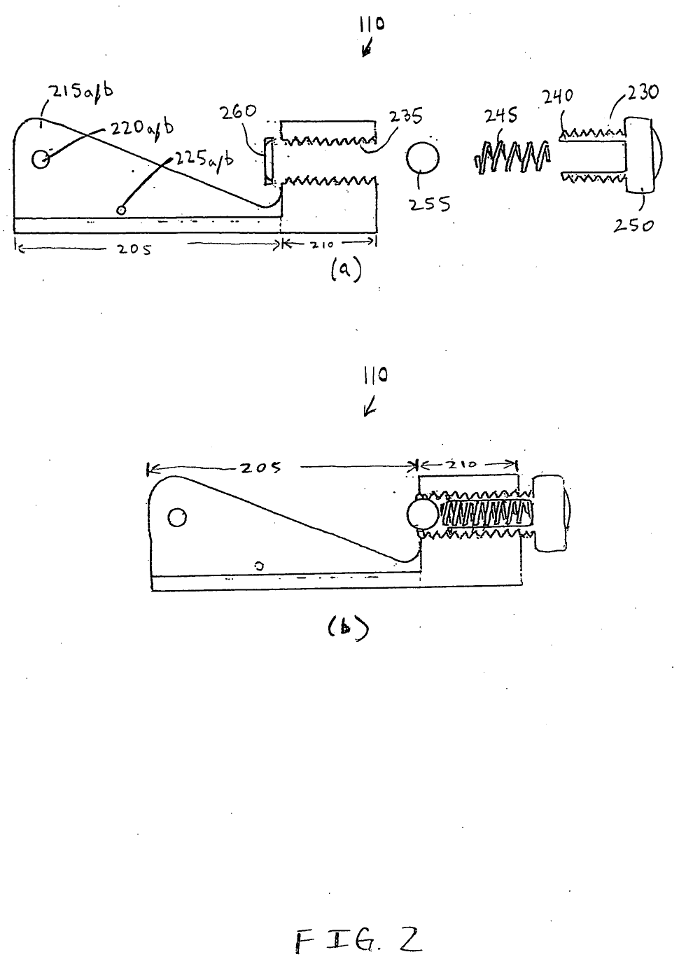

FIG. 2 illustrates the mounting unit 110 in detail. As shown in images (a) and (b) of FIG. 2, the mounting unit 110 includes a first portion 205 and a second portion 210. The first portion 205 includes a pair of sloped sides 215a/b, the sides 215a/b being separated by a distance suitable for disposing the indicating unit 120 in a channel formed therebetween. The sides 215a/b include a first set of holes 220a/b at an end thereof and a second set of holes 225a/b at a middle thereof. The second portion 210 includes a detent unit, the detent unit for holding the indicating unit 120 at a second end of the first portion 205 to a first end of the second portion 210. The detent unit includes a bolt 230 that can be inserted into a second end of the second portion 210. The bolt 230 is configured such that it may be screwed into a threaded channel 235 of the second portion 210. The bolt 230 includes a hollow threaded tube 240 that is open at one end for receiving a spring 245. At the other end of the tube 240 is a nut 250 that enables the tube 240 to be screwed into the channel 235. The nut 250 may be contoured to have grooves such that it may easily be grasped and rotated. The detent unit further includes a ball 255 such as a ball bearing and a washer 260 positioned at the first end of the second portion 210. The washer 260 may be chamfered such that it allows the ball 255 to protrude but not exit therethrough. The mounting unit 110 may be formed of silicon, plastic or metal. The detent unit may also be formed of silicon, plastic or metal.

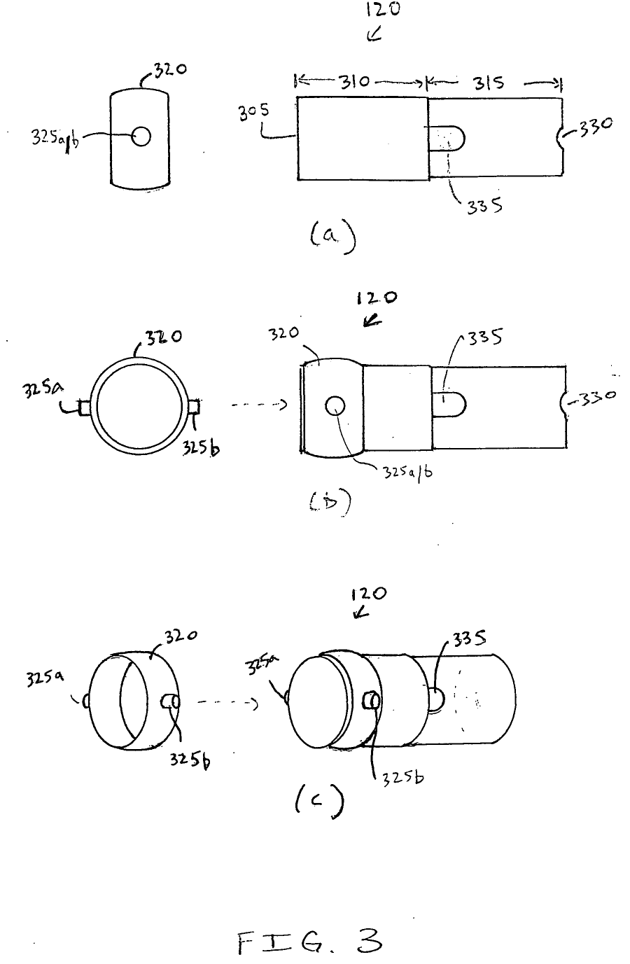

FIG. 3 illustrates the indicating unit 120 in detail. As shown in images (a-c) of FIG. 3, the indicating unit 120 includes a housing 305 including a first portion 310 and a second portion 315. The indicating unit 120 also includes a clip 320, the clip 320 for being secured to the first portion 310 of the housing 305 as shown in images (b) and (c). The clip 320 may be secured to the first portion 310 by slipping it onto the first portion 310. The clip 320 may also be integrally formed with the first portion 310. The clip 320 includes protruding connectors 325a/b, such as lugs, for being inserted into the first set of holes 220a/b of the sides 215a/b of the mounting unit 110. The protruding connectors 325a/b should be cylindrically formed so that the indicating unit 120 can swivel in an out of the channel formed by the sides 215a/b of the mounting unit 110.

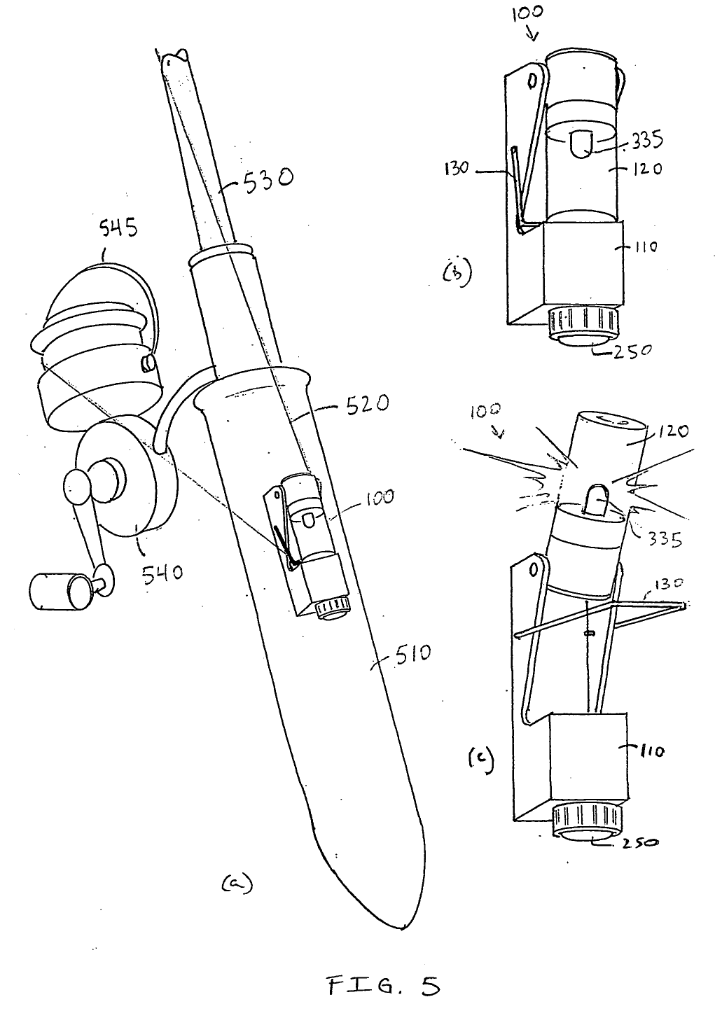

As further shown in FIG. 3, the second portion 315 includes a concave portion 330 at and end thereof. The concave portion 330 is used such that when the indicating unit 120 lies in the channel of the mounting unit 110, a portion of the ball 255 may rest therein to hold the indicating unit 120 in place. An amount of tension used to hold the indicating unit 120 in place may be increased or decreased by adjusting the nut 250 accordingly. For example, the nut 250 could be rotated such that it causes the ball 255 to protrude further through the washer 260, thus increasing the amount of tension applied between the ball 255 and the indicating unit 120. In this scenario, a fish strike of greater force would be needed to cause the indicating unit 120 from being triggered. This will be described in more detail hereinafter with reference to FIG. 5. The indicating unit 120 also includes a light emitting element 335. The light emitting element 335 may be, for example, a light emitting diode (LED), an organic light emitting diode (OLED) or a light bulb that is illuminated in response to movement.

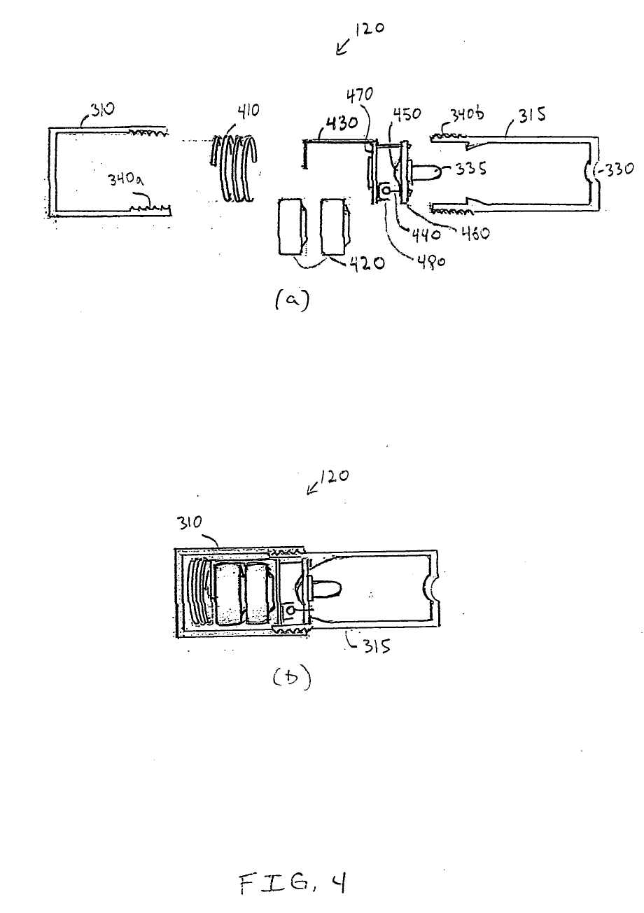

A more detailed description of the indicating unit 120 and the circuitry used for illuminating the light emitting element 335 will now be described with reference to FIG. 4. As shown in images (a) and (b) of FIG. 4, the indicating unit 120 includes an indicating circuit, the indicating circuit including a spring 410, a power source 420 such as a battery or a pair of batteries, a metal strip 430, a contact switch 440 such as a spring located in a channel 480, a timing circuit 450, a printed circuit board 460, a circuit unit 470 and the light emitting element 335.

The power source 420 is connected at one end between the spring 410 and a portion of the metal strip 430 and at another end to a bottom side of the circuit unit 470. The circuit unit 470 includes the contact switch 440 and the printed circuit board 460, with the metal strip 430 connected to a bottom portion thereof. The printed circuit board 460 includes the light emitting element 335 and the timing circuit 450 coupled thereto. The indicating circuit is motion sensitive such that when it is moved, the contact switch 440 touches the channel 480 and closes the indicating circuit, thereby causing the light emitting element 335 to be energized and thus illuminated by the power source 420. Once the power provided by the power source 420 has dissipated, the light emitting element 335 stops being illuminated.

Although the contact switch 440 typically determines an amount of time the light emitting element 335 is illuminated, the timing circuit 450 may be used to adjust the illumination time. For example, indicating unit 120 may include an adjustable knob connected to the timing circuit 450 or the timing circuit 450 may be programmed to increase or decrease the amount of time the light emitting element 330 is illuminated. Further, the light emitting element 335 may be illuminated either continuously or discontinuously in response to movement of a fishing line as will be described below with reference to FIG. 5. For example, as the switch 440 periodically touches the channel 480 when vibrated due to motion of the fishing line, the light emitting element 335 will be discontinuously illuminated. In other words, the light emitting element 335 will flash.

Although the indicating circuit includes a variety of elements such as the spring 410 for securing the components of the circuit in place or the timing circuit 450 for adjusting the amount of time the light emitting element 335 is to be illuminated, it is to be understood that the indicating circuit may be constructed in some embodiments with or without these or other components. Further, the indicating circuit may be any of a variety of motion indicating circuits such as, for example, those disclosed in U.S. Pat. No. 6,467,939, a copy of which is incorporated by reference herein in its entirety.

Image (b) of FIG. 4 illustrates the location of the indicating circuit in the indicating unit 120. As shown in image (b), the indicating circuit can be located solely in the first portion 310 of the indicating unit 120 with the light emitting element 335 protruding into the second portion 315 of the indicating unit 120. The first portion 310 and the second portion 315 of the indicating unit 120 may be connected to each other via threaded sections. For example, the first portion 310 may include a female threaded portion 340a and the second portion 315 may include a male threaded portion 340b or vice versa. The first and second portions 310 and 315 may also be connected to each other by inserting a male insert section of the second portion 315 into a female receiving section of the first portion 310 or vice versa.

Although the housing 305 of the indicating unit 120 is been shown as being cylindrical, the housing 305 may be formed of any shape suitable for use with the mounting unit 110. Moreover, the second portion 315 of the housing 305 may be a clear plastic diffuser that enables light emitted by the light emitting element 335 to be observed. The diffuser may be colored. The light emitting element 335 may also be colored.

Image (a) of FIG. 5 illustrates the fish strike indicating apparatus 100 mounted on a sand spike 510 according to an embodiment of the present invention. It is to be understood that although a sand spike is shown here, the fish strike indicating apparatus 100 may be mounted on any type of rod holder. For example, since many boat rod holders are flush mount with a surface of the deck, a short sleeve may be placed therein extending above the surface to provide a suitable mount for the fish strike indicating apparatus 100. The fish strike indicating apparatus 100 may be mounted onto the sand spike 510 by using a basic fastener such as Velcro attached to a bottom side of the mounting unit 110 and a portion of the sand spike 510. In addition, the fish strike indicating apparatus 100 may be mounted onto the sand spike 510 by configuring the mounting unit 110 such that it includes a pair of openings a sides thereof for receiving a fastener such as a cable tie, thread or the like, such that the mounting unit 110 can be secured to the sand spike 510. Further, the bottom side of the mounting unit 110 may have a concave or U-like shape such that it is contoured to fit to the sand spike 510. In addition, the mounting unit 110 may simply be glued onto the sand spike 510.

As shown in image (a), a fishing rod 530 is placed into the rod holder 510 after a line 520 has been cast. At this time, a fisherman may lift a bail 545 of a reel 540 connected to the rod and connect the line 520 to the fish strike indicating apparatus 100. This may be accomplished by lifting the indicating unit 120 as shown in image (c) of FIG. 5 and by lifting an underlying line snag prevent 130 such as a piece of wire or metal that is coupled to the sides 215a/b of the mounting unit 110 via the second set of holes 225a/b. The line 520 is placed beneath the indicating unit 120 and then the indicating unit 120 is snapped into place and secured by the ball 255 as shown in images (a) or (b). It is to be understood that at this point the bail 545 may left open to free spool the line 520 upon a fish strike or the bail 545 can be closed to hold the line 520 in place and a line drag may be set.

Upon movement of the fishing line 520 due to a fish striking bait on the line 520 and thus pulling the line 520 up the rod 530, the indicating unit 120 flips up as shown in image (c) thus causing the light emitting element 335 to illuminate, thereby providing a visual indication to a fisherman that a fish has struck. This can be particularly useful to a night-fisherman as visually minding a fishing rod at night can be difficult. This can also be useful to a fisherman who desires to fish using more than one or rod or to a fisherman who desires not to use a rod mounted fish strike indicator.

It should be understood that the above description is only representative of illustrative embodiments. For the convenience of the reader, the above description has focused on a representative sample of possible embodiments, a sample that is illustrative of the principles of the invention. The description has not attempted to exhaustively enumerate all possible variations. That alternative embodiments may not have been presented for a specific portion of the invention, or that further undescribed alternatives may be available for a portion, is not to be considered a disclaimer of those alternate embodiments. Other applications and embodiments can be implemented without departing from the spirit and scope of the present invention. It is therefore intended, that the invention not be limited to the specifically described embodiments, because numerous permutations and combinations of the above and implementations involving non-inventive substitutions for the above can be created, but the invention is to be defined in accordance with the claims that follow. It can be appreciated that many of those undescribed embodiments are within the literal scope of the following claims, and that others are equivalent.

What is claimed is:

1. A fish strike indicating apparatus, comprising:
a mounting unit for mounting to a rod holder, the mounting unit including a first portion and a second portion;
an indicating unit for indicating movement of a fishing line, the indicating unit including a clip for connecting the indicating unit to a first end of the first portion of the mounting unit; and
a detent unit for holding the indicating unit at a second end of the first portion of the mounting unit to a first end of the second portion of the mounting unit.

2. The fish strike indicating apparatus of claim 1, further comprising:
a fastener for fastening the mounting unit to the rod holder.

3. The fish strike indicating apparatus of claim 2, wherein the fastener is Velcro.

4. The fish strike indicating apparatus of claim 2, wherein the rod holder is a sand spike.

5. The fish strike indicating apparatus of claim 1, wherein the detent is a ball detent.

6. The fish strike indicating apparatus of claim 5, wherein the ball detent comprises:
a ball bearing for holding the indicating unit in a temporarily fixed position;
a washer for securing the ball bearing in the ball detent; and
a hollow bolt including,
a spring for pushing the ball bearing against the indicating unit; and
a nut for adjusting tension between the spring and the ball bearing.

7. The fish strike indicating apparatus of claim 1, wherein the mounting unit further comprises:
a first opening and a second opening in the first portion of the mounting unit.

8. The fish strike indicating apparatus of claim 7, wherein the clip further comprises:
a first protruding connector and a second protruding connector for inserting into the first and second openings to connect the clip to the first portion of the mounting unit.

9. The fish strike indicating apparatus of claim 8, wherein the mounting unit further comprises:
a third opening and a fourth opening in the first portion of the mounting unit; and
a line snag prevent having a first protruding connector and a second protruding connector for inserting into the third and fourth openings.

10. The fish strike indicating apparatus of claim 1, wherein the indicating unit further comprises:
a battery;
a timer;
a printed circuit; and
a light emitting element.

11. The fish strike indicating apparatus of claim 10, wherein the light emitting element is an LED, OLED or a light bulb.

12. The fish strike indicating apparatus of claim 10, wherein the indicating unit is encased in a housing, the housing comprising a first portion and a second portion, the first portion for storing the battery, timer, printed circuit, and light emitting element, the second portion for displaying light emitted by the light emitting element.

13. The fish strike indicating apparatus of claim 12, wherein the first portion of the housing is coupled to the second portion of the housing via a coupling means.

14. The fish strike indicating apparatus of claim 12, wherein the second portion includes a concave portion for being held by the detent unit.

15. A fish strike indicating apparatus, comprising:
a mounting unit for mounting to a rod holder, the mounting unit including a pair of sloped sides and a hollow threaded insert;
an indicating unit for indicating movement of a fishing line, the indicating unit including a connector for pivotally connecting to the mounting unit via the sloped sides, a concave portion and a light source for emitting light upon movement of the fishing line; and
a detent unit coupled through the hollow threaded insert, the detent unit including a ball bearing for resting in the concave portion of the indicating unit and a threaded bolt for adjustably securing the indicating unit against the ball bearing.

16. The fish strike indicating apparatus of claim 15, wherein the rod holder is a plastic sleeve.

17. The fish strike indicating apparatus of claim 15, wherein the mounting unit further comprises:
a snag prevent for prevent the fishing line from being snagged in between the indicating unit and the sloped sides upon movement of the fishing line.

18. The fish strike indicating apparatus of claim 17, wherein upon movement of the fishing line, the indicating unit is released from the detent unit and thrust in an outward direction while remaining pivotally connected to the sloped sides.

19. The fish strike indicating apparatus of claim 17, wherein the snag prevent is a wire or piece of metal.

20. The fish strike indicating apparatus of claim 15, wherein the indicating unit comprises:
a spring connected to a power source, the power source connected to the light source, the light source disposed on a printed circuit board;
a metal strip connected at one end between the spring and the power source and connected at another end to the printed circuit board;
a switch connected to the printed circuit board, the switch responsive to movement of the fishing line to energize the light source; and
a timing circuit for controlling a rate at which the light bulb is energized, wherein the rate at which the light bulb is energized determines an amount of time the light source is illuminated.
